(19) United States
(12) Patent Application Publication
(10) Pub. No.: US 2012/0077402 A1
(43) Pub. Date: Mar. 29, 2012

(54) SEMI-FINISHED TEXTILE PRODUCT, PARTICULARLY PREPREG, MANUFACTURED FROM NON-WOVEN FIBER FABRIC

(75) Inventors: Sebastian Grasser, Meitingen (DE); Jan Verdenhalven, Hofheim (DE); Florian H. Gojny, Kelkheim (DE); Rudolf Engertsberger, Morschwang (AT); Christian Howe, Paderborn (DE)

(73) Assignee: Benteler SGL GmbH & Co. KG, Paderborn (DE)

(21) Appl. No.: 13/071,621

(22) Filed: Mar. 25, 2011

(30) Foreign Application Priority Data
Mar. 25, 2010 (DE) 10 2010 012 962.3
Oct. 12, 2010 (DE) 10 2010 042 349.1

(51) Int. Cl. B32B 5/02; B32B 9/00; B32B 27/04; B32B 37/12; B32B 37/02

(52) U.S. Cl. 442/179; 156/94

(57) ABSTRACT

A method for manufacturing a semi-finished textile product, particularly a prepreg, from carbon fibers preimpregnated with a matrix material, includes the steps of manufacturing non-woven fabric having at least 10% carbon fibers and/or a fleece having at least 10% carbon fibers. At least a portion of the fibers used for manufacturing the fabric and/or the fleece are waste fibers and/or recycling fibers. The non-woven fabric and/or fleece is impregnated with a matrix material selected from the group thermoplastic, thermoset, elastomers and any chosen mixtures of two or more of the aforementioned materials.

### CROSS-REFERENCES TO RELATED APPLICATIONS

This application claims the priorities of German Patent Applications, Serial Nos. 10 2010 012 962.3, filed Mar. 25, 2010, and 10 2010 042 349.1, filed Oct. 12, 2010, pursuant to 35 U.S.C. 119(a)-(d), the content of which are incorporated herein by reference in its entirety as if fully set forth herein.

### BACKGROUND OF THE INVENTION

The present invention relates to a method of manufacturing a semi-finished textile product, particularly a prepreg, of carbon fibers pre-impregnated with a matrix material; a semi-finished textile product obtained from this method, particularly prepreg; as well as use of the prepreg particularly for manufacturing structural composite material components, as well as especially for manufacturing structural composite material components, as particularly used for manufacturing outer skin and structural components for motor vehicles and transport vehicles.

Composite materials containing carbon fibers, such as, for example carbon-fiber reinforced plastics material (CFK), which is composed of a synthetic material matrix consisting, for example of phenol resin or epoxide resin, in which are embedded carbon fibers or graphite fibers in one or more fiber layers; these materials have particularly in the fiber direction a high strength and stiffness and are additionally distinguished in comparison to other materials, such as, for example, steel, by a low weight, a low thermal expansion and by an excellent resistance to temperature changes. Because of these advantageous properties, such carbon fibers containing composite materials are used in many technical fields and particularly increasingly in the automobile industry, for example, as material for structural components or for outer skin components of a motor vehicle.

However, the composite materials used presently for this purpose have a number of disadvantages.

For example, structural components of motor vehicles are typically manufactured of composite material containing typically carbon fibers in the form of anisotropic composite material which contain nest-type fabric structures. However, structural components are frequently subjected to isotropic load conditions; therefore, these composite materials are frequently constructed of several nest-type fabric layers which are specifically oriented relative to each other in order to take into consideration the isotropic load conditions thereof. Therefore, the manufacturing method for such composite materials is very cumbersome and the composite products are expensive as a result. Another disadvantage of these materials is that their draping properties are poor.

On the other hand, outer skin components or visible components of motor vehicles are usually manufactured of composite materials which contain carbon fibers in the form of fabric structures. They can be manufactured relatively inexpensively by a resin injection method (RTM-method), “Resin Transfer Molding”-Method. However, these materials have, among other problems, an unsatisfactory surface quality. For example, the surface quality is negatively influenced by the fact that at the points of intersection of the fabric an increased shrinkage of the matrix material occurs, so that the fabric structure on the surface of the composite material becomes visible.

For these reasons, there is a demand for composite materials which contain carbon fibers, which have improved properties, such as a better surface quality, and draping capability, which are of relatively simple construction and can be manufactured especially inexpensively. In particular, there is a demand for semi-finished products, especially a prepreg, of appropriate composite materials which can be further processed simply and inexpensively into the desired end products, and for a method with which such semi-finished products, particularly prepregs, or end products of composite materials can be easily and inexpensively manufactured.

In particular, there is a demand for appropriate materials which have a percentage of recycling fibers which is as high as possible in order to be able to meet the reuse ratio for motor vehicles required by law and for the manufacturing method thereof.

It would therefore be desirable and advantageous to obviate other prior art shortcomings and to provide an improved to obviate prior art shortcomings and to provide a method for manufacturing a semi-finished textile product, particularly a prepreg, from carbon fibers which have been preimpregnated, a matrix material, which is simple and inexpensive to carry out and in which a high proportion of recycling fibers can be used, and leads to a semi-finished textile product that has an excellent surface quality and a good draping quality.

### SUMMARY OF THE INVENTION

According to one aspect of the present invention, a method for manufacturing a semi-finished textile product, particularly a prepreg, of preimpregnated carbon fibers with a matrix material, includes the steps of a) manufacture of non-woven fabric consisting of at least 10% carbon fibers and/or of a fleece composed of at least 10% of carbon fibers, wherein at least a portion of the fibers used for manufacturing the non-woven fabric and/or the fleece are waste fibers and/or recycling fibers, and b) impregnating the fabric or fleece with a matrix material, selected from the group which consists of thermoplastic materials, thermoset materials, elastomers, and any chosen mixture of two or more of the before mentioned materials.

The method according to the invention makes it possible in a simple and inexpensive manner to manufacture semi-finished textile products, particularly prepregs from a matrix material preimpregnated by carbon fibers with a high proportion of recycling fibers and/or waste fibers as well as with an excellent draping capability which can be further processed simply and inexpensively into the desired end products with a high strength and stiffness at comparatively low weight and with an excellent surface quality. Due to the use of a non-woven fabric or fleece in the process step a), a targeted anisotropic character of the properties, particularly the strength and the stiffness of the semi-finished product and the later finished product is adjusted. In addition, the use of a non-woven fabric or fleece in the method step a) obtains a semi-finished product with an excellent draping capability which is significantly better than the draping properties of a semi-finished product which contains as fiber material exclusively meshed goods or web goods. Finally, the method according to the invention achieves because of the use of old fibers or waste fibers and/or recycling fibers a closed or at least almost closed material cycle. Since in the method according to the invention, the use of newly manufactured carbon fibers, whose manufacture is very complicated and energy-intensive, is omitted or its quantity is at least significantly reduced, but instead of its recycling fibers and/or waste fibers, the method of the invention is also less expensive than the methods known from the prior art for manufacturing appropriate semi-finished products in which new fibers can be used. Consequently, the method according to the invention is not only a method for manufacturing a semi-finished product from carbon fibers preimpregnated with a matrix material, but especially also a method for reusing or recycling of old fibers and/or waste fibers.

Within the scope of the invention, recycling fibers are understood to be fibers manufactured from used fibers, wherein the fibers can be from any used fiber material, such as, mesh goods, knitted fabrics, nest-type fabric, fiber mats, fiber strands, fleeces, non-woven fabrics or composite materials, such as CFC, CFK, carbon-fiber reinforced concrete, or the like.

In addition, the term waste fiber within the sense of the present invention is a fiber which has been obtained from production wastes, such as cuttings, production waste, and the like, i.e., also of new fiber material it is further within the scope of the present invention if the fibers which are from production wastes, such as cuttings, production excess, i.e. also of new fiber material, wherein the production waste may include any chosen fiber material, such as, for example, fabric, knitted fabric, nest-type fabric, fiber mats, fiber strands, felt, fleece and/or composite material CFC, CFK, carbon fiber reinforced concrete, prepreg or the like.

A carbon fiber in the sense of the present invention can be a fiber which is at least 90% carbon, preferably at least 95% carbon, especially preferred at least 98%, especially preferred 99% and most preferred completely of carbon.

According to another advantageous feature of the present invention, the impregnation of the fabric and/or of the fleece of the matrix material can be carried out in step b) by a method which is selected from the group which consists of prepreg method, wet pressing method, resin infusion method, foil lamination method and vacuum (“Vacuum Assisted Resin Infusion”- or VARI-) method. Through any of these aforementioned methods surprisingly it is possible to achieve an excellent impregnation of the carbon fiber fabric or the carbon fiber fleece, so that semi-finished textile products are obtained, in which the fiber material is embedded especially homogeneously in the matrix. By the quasi-isotropic orientation of the fibers in the plane and the homogenous distribution of the matrix shrinkage, it is possible to prevent optical disturbances. This was surprising because fleeces and felts are because of their low permeability in the fiber direction difficult to impregnate. Such a good impregnation, not to speak of a homogenous embedding of fibers in the matrix, is not possible with other technologies, especially not with the RTM-method, in which the injection method or the resin distribution of the matrix along the textile alignment is not possible.

Particularly good results are in this connection achieved if the impregnation of the fabric and/or the fleece in the step b) by a liquid prepreg method with liquid or semi liquid polymers or oligomers by a powder-prepreg method or a wet pressing method is carried out.

Basically, in step a) of the method of the invention fiber mixtures of new fibers and waste fibers and/or recycling fiber with any chosen ratios of the new fibers to the waste fibers and/or recycling fibers can be utilized as long as it is ensured that a fabric or a fleece which is at least 10% carbon fibers is obtained. In order to keep the reusing ratio as high as possible, a further development of the inventive concept proposes that in the method step a) for producing the fleece and/or the felt a fiber mixture is used which is of at least 20%, preferably at least 50%, especially preferably 80%, especially preferably 90%, very especially preferably 95%, and most preferred completely of waste fibers and/or recycling fibers.

Depending on the purpose of application, in the semi-finished product, in relation to the total carbon fiber quantity a more or less high proportion of carbon fibers is required in the semi-finished product. Good results were especially obtained when the carbon fiber quantity was in relation to the total fiber content at least 20%, preferred at least 40%, especially preferred 60%, particularly preferred at least 80%, and especially preferred at least 90%, and at most 100%.

Accordingly, the proportion of carbon fibers in the waste fibers used in method step a) and/or recycling fibers may vary. Only, as an example, in the method step a), waste fibers and/or recycled fibers can be arranged, at least 10% of which, preferably at least 30%, especially preferred at least 60%, very especially preferred at least 80% and most preferred, 100% are of carbon fibers. The remaining waste fibers and/or recycling fibers can be composed of any chosen material, such as glass and/or cotton.

To the extent that in method step a) a fiber mixture is used which contains aside of waste fibers and/or recycling fibers also newly manufactured carbon fibers, the latter can be manufactured, for example, in such a way that initially from these carbon-containing initial materials, such as, for example, polyacrylnitrile, oxidized polyacrylnitril or cellulose, fibers are spun before they are subsequently carbonized and stretched and possibly graphitized before the fibers manufactured in this manner are finally surface treated and possibly coated with black wash.

As initial material for the manufacture of the non-woven fabric or fleece not only monofilaments can be used, but also especially bifilaments or mixtures of two or more mono- and/or bifilaments. For example, stretch-torn filaments or fibers can also be used. Especially for the manufacture of non-woven fabrics or fleeces, mixtures of carbon fibers and fibers of a thermoplastic material can be used, which later facilitates a direct consolidation of the semi-finished textile product into an organic sheet.

Advantageously, in step a) for manufacturing the non-woven fabric and/or fleece, fibers having a length of between 1 and 500 mm, especially preferred are fibers with a length of between 5 and 500 mm, especially preferred with a length of between 10 and 250 mm. Currently preferred are fibers having a length of between 20 and 220 mm are used. Alternatively, for manufacturing the non-woven fabrics and/or fleeces containing the carbon fibers can be used for non-woven fabrics and/or fleeces containing carbon fibers, also mixtures of short cut fibers having a length of between 1 and 5 mm, and of long fibers having a length of between 5 and 500 mm can be used, especially preferred are long fibers having a length of between 10 and 250 mm. Currently preferred are fibers having a length of 20 and 220.

The waste fibers and/or recycling fibers can be manufactured with any conceivable manner of waste fiber material or of used fiber material. For example, the recycling fibers can be manufactured of fiber material impregnated with a matrix material with preimpregnated fiber material or composite material containing fibers, especially carbon fibers containing composite material, such as CFC or CFK, by comminuting the fiber material preimpregnated with a matrix material or composite material containing the fibers. Before the fiber material is then separated from the matrix material. The comminution is carried out preferably with a shredder, with a cutting mill, with an impact mill, or a hammer mill in such a way that particles having a length of between 1 and 500 mm are obtained.

In this embodiment, the separation of the matrix from the carbon fibers, for example, by solvolysis, i.e., by contacting the material with an acid, for example, with a mineral acid, such as sulfuric acid or nitric acid with a lye, such as sodium bicarbonate, or with solvent. Alternatively, the separation of the matrix from the carbon fibers can occur inevitably during comminution. In accordance with another alternative, the removal of the matrix can also be effected by pyrolysis of the matrix material. Subsequently, the matrix can be severed from the carbon fibers, for example, by sifting or screening, wherein the screening is carried out, for example, in a rotation screener, wind screener or zigzag screener. Finally, the obtained fiber material can additionally be coated with black wash.

According to another advantageous feature, the above-described non-woven fabric having at least 10% carbon fibers and/or fleece having at least 10% carbon fibers can be used in the method according to the invention, in combination with at least one other fiber material, wherein the other fiber material can be selected from a group including fabrics, nest-type fabrics, unidirectional (UD-) strands, belts, non-woven fabrics, fleeces and any chosen mixture of two or more of the materials mentioned above. These fiber materials have a higher mechanical stability and especially a higher tensile strength than the non-woven fabric manufactured from at least 10% carbon fibers in method step a) and/or the fleece consisting of at least 10% carbon fibers, which is the reason why the non-woven fabric is mechanically stabilized by a combination of different fiber materials. As a result, when the method according to the invention is carried out, and especially during carrying out the method step b), any created stresses are absorbed by the other fiber material, so that the non-woven fabric or the fleece is only subjected to low tensile stresses, and damage or even destruction of the non-woven fabric or the fleece is reliably prevented, so that the non-woven fabric or fleece can be further processed into the semi-finished textile product and subsequently from the semi-finished textile product into the end product.

The individual fiber materials can be arranged in the form of a laminate, or the individual fiber materials are combined, if possible, in a layer with each other. An example for the latter case is the realization of non-woven fabric and nest-type fabric, whereas examples for a laminate structure are structures of non-woven fabric/fabric/non-woven fabric or of non-woven fabric/nest-type fabric/non-woven fabric. Basically, the laminate can consist of at least one non-woven fabric and at least one fabric layer of which at least one non-woven fabric layer and at least one nest-type fabric layer consist of a non-woven nest-type fabric with core material, wherein the core material is, for example, a foam which can have honeycomb structure; wherein the material may be a cardboard core or any other core material. In this connection, the non-woven fabric or fleece layers are preferably in such laminates at the outer side of the laminate, so that the semi-finished textile product or the resulting end product may have in comparison to fabrics and mesh goods advantageous surface properties.

In order to keep the reusable material ratio as high as possible, in accordance with another advantageous feature of the present invention, it is proposed that also the other fiber material group selected from the above mentioned group can have a proportion of the waste fibers and/or recycling fibers in relation to the total amount of fibers in the other fiber material preferably at least 20%, especially preferably at least 50%, further preferred at least 80%, especially preferred at least 90%, very especially preferred at least 95%. Currently preferred is 100%.

According to another advantageous feature of the present invention, another fiber material selected from the aforementioned group can be used as fiber material, which is composed of two or more of the aforementioned materials, composed of carbon fibers, glass fibers, polymer fibers and mixtures thereof. Examples of suitable polymer fibers include, but are not limited to, polyamide fibers, polyester fibers, polypropylene fibers, polyacrylnitrile fibers, fibers of oxidized polyacrylnitrile as well as fibers of copolymers of two or more of the aforementioned materials. Such fiber materials have a high mechanical strength and are therefore especially suitable as non-woven material and/or the fleece and, therefore are imminently suitable as fiber materials for mechanically stabilizing the non-woven fabric and/or the fleece.

In this connection, the combination, i.e. in the case of the formation of a combination of the two fiber materials in a layer, the mixing of the two fiber materials, and in the case of the formation of a laminate structure, the lamination of the two material layers, i.e., the combination of, first, the at least 10% carbon fibers of which the non-woven fabric exists and/or the fleece existing of at least 10% carbon fibers, and of, second, the at least one other fiber material selected from the aforementioned group, during the method step b), i.e., during the impregnation or prior to the impregnation, wherein a combination of the two fiber materials prior to the impregnation is preferred. To the extent that the non-woven fabric or the fleece is combined in a layer with each other, as, for example, in the case of working of non-woven fabric and nest-type fabric, the combination of the two fiber materials can be carried out, particularly preferred during the manufacture of the non-woven fabric or the fleece during method step a).

Basically, in method step b), all thermoplastic materials, thermoset materials and elastomeric materials, each can be used as matrix material individually or in mixtures with each other. However, good results have been found especially when the matrix material is selected from that group which is selected from epoxide resins, phenol resins, vinyl ester resins, polyester resins, polyurethane resins, benzoxazine resins, novolakes, cyanateester resins, bismaleimide resins, bisoxazolines, polyolefines, such as, for example, polypropylene, technical thermoplastic materials, such as, for example, polyamide and any chosen mixtures of two or more of the aforementioned materials.

In a further development of the concept of the invention, it is proposed that to impregnate the non-woven fabric or the fleece with such an amount of matrix material that the semi-finished product after the method step b) has a content of matrix material between 1 and 90% by weight, particularly preferred between 30 and 70% especially between 40 and 65% by weight.

As explained above, the impregnation of the non-woven fabric and/or the fleece with the matrix material in step b) is carried out by a method which is selected from that group which is among those prepreg methods, wet pressing method, resin infusion method, foil coating method and vacuum reinforced (VARI)-methods, because each of the aforementioned methods surprisingly produces a good impregnation of the carbon fiber, fabric or fleece which are usually very difficult to impregnate. Especially good results are obtained if the impregnation of the fabric and/or fleece is carried out with the matrix material in step b) by a powder prepreg method, a liquid prepreg method or a wet press method.

In the wet press method, a cut of the fabric or fleece manufactured in the method step a) is placed in an open press form before liquid or solid matrix material is placed in front of the fabric or fleece, the matrix material cast or sprayed, or placed before the press form is closed and a pressure of preferably between 0.1 and 1.00 bar is applied. Because of the pressure in the press form, equal flow paths develop to all sides, so that the matrix material is uniformly distributed in the fabric or fleece.

Advantageously, the impregnation of the fabric or fleece with the matrix material in method step b), by powder prepreg method and most preferred by a liquid prepreg method. When a powder prepreg method is used, this is carried out preferably with liquid matrix systems having a viscosity at room temperature of 10 to 1.000 000 mPa's, especially preferred with a viscosity at room temperature of 400 to 100 000 mPa's and especially preferred with a viscosity at room temperature of 1000 to 25 000 mPa's.

In order to avoid in the prepreg method influence of excessive tensile forces of the fabric or fleece, it is provided independently of the fact of whether the powder prepreg method or the liquid prepreg method is used that the method is carried out in a such a way that the fiber or fleece before the method step b) is coated unilaterally or if the fleece or the fabric are placed without any additional fiber material, both sides of the carrier material are coated with a carrier foil or with a carrier paper. The carrier foil can be a composition of, for example, of a thermoplastic material together with, for example, a film or a foil of polyester. The thermoplastic film or foil can than also be coated.

Alternatively, carrier paper can be used for this purpose, wherein the paper preferably as a weight or surface weight of 10 to 300 g/m² and particularly preferred of 50 to 130 g/m².

In the case of a thermoplastic carrier foil, the carrier material can be applied especially by means of calendaring onto the fiber or onto the fleece.

As soon as the impregnation of the fabric or the fleece with the matrix material in method step b) is carried out by a powder prepreg method, the matrix material is applied in the form of powder onto the fleece or fabric by, for example, dipping the fleece or fabric into a powder suspension containing impregnating bath, caused by direct casting of the carrier material or by electrostatic connection. It may take place as a result of the pulverous matrix material, in particular with the two last-mentioned method, selectively on one side of the fabric or fleece, or, preferably with the first-mentioned method on both sides of the textile fabric.

When the matrix material is a thermoplastic material, it is attached with the pulverous matrix material preferably by melting on the fabric or fleece, wherein the melting takes place by guiding the powder-coated fabric or fleece through a heating zone, adjusted to a temperature slightly above the melting point of the thermoplastic material. In this way, the falling off of the powder from the fleece or felt during the subsequent steps can be avoided.

According to another advantageous feature of the present invention, the matrix material may be a thermoset material. This is advantageously applied in the form of a powderous prepolymer onto the fabric or fleece, before the powderous material is at a temperature slightly above the melting temperature of the thermoset prepolymer, but lower than the cross linking temperature of the thermoset material onto the fleece or fabric. In accordance with the invention, a thermoset prepolymer in is, in agreement with the correct common definition of this term, understood to be an oligomere or polymer which can be transposed onto a thermoset through cross linking. The cross linking, if the thermoset prepolymer is sufficiently functionized, can take place without cross linking agent, or, it can take place with a cross linking agent. As cross linking agent, it can be used, a compound which is selected from the group comprising amines, for example hexamethylenetramine, acidic hydrides, Lewis-acid, radicalizers, such as in particular peroxides, azoconnections and the like, through transfer compounds, such as transfer metal salts, transfer metal organization compounds and the like, organic acids, inorganic acids, and any chosen mixture of the aforementioned compounds. For vinylester and polyester, especially suitable as crosslinking agents are especially radicalizers and transfer metal compounds, while as phenol resins are especially suitable as crosslinking agents amines, inorganic acid and organic acids, and for the remaining matrix precursors from the aforementioned list of suitable cross linking agents are amine, acid anhydride and Lewis-acids.

If the matrix material is a thermoset material, this material is prior to the later complete hardening preferably after the application and after the fixing thermally and/or chemically prelinked or staged, which causes a molecular weight increase, which provides this material with the highest stability.

If the impregnation of the fabric and/or the fleece with the matrix material in method step b) takes place by the liquid prepreg method, the matrix material can be placed on the fabric or fleece either directly or indirectly, for example through spraying, immersion, casting or painting, in a solution containing suspension emulsion or hot melt applied to the fabric matrix.

Independently of whether the prepreg method is carried out as a powder prepreg method or as liquid prepreg method, the impregnation takes place in method step b) preferably by a pressure temperature treatment, i.e., at an increased temperature and increased pressure.

Moreover, in a further development of the concept of the invention, it is proposed that the impregnation in method step b) is carried out at a temperature which is 1 to 400° C., preferably 10 to 200° C. and preferably 30° C. to 150° C. above the glass transfer temperature of the non-linked matrix material.

The present invention also desires to provide an improved textile semi-finished product, particularly prepreg, of a carbon fiber previously preimpregnated with matrix material, which can be achieved with an above mentioned method.

Such a semi-finished textile includes matrix material which is selected from the group including thermoplastic, thermoset, elastomers and any mixture of two or more aforementioned materials, wherein a fabric and/or fleece is embedded in the matrix, wherein the fabric or fleece includes at least 10% carbon fibers and contains waste fibers and/or recycling fibers.

According to another advantageous feature of the present invention, an additional fiber material may be embedded in the matrix material, wherein the additional material is preferably selected from the group which includes fabrics, nest-type fabric, unidirectional (UD-) strands, strips, belts, felts and any desired mixture of two or more of the preceding materials.

The semi-finished textile product in accordance with the present invention is distinguished by the fact that it is simple and inexpensive to manufacture and this with the use of a high proportions of recycling fibers and/or waste fibers. Moreover, the semi-finished textile product according to the invention has excellent draping capability, so that it can be processed simply and inexpensively into the desired end product with high strength and stiffness, while having a relatively low weight and an excellent surface quality. In particular, in the semi-finished product, according to the invention it is possible because of the use of a fabric or fleece to adjust a targeted anisotropic property of the product because of the preferred orientation when manufacturing the fabric in particular with respect to the strength and the stiffness.

According to another advantageous feature of the present invention, the semi-finished textile product according to the invention is manufactured by a method selected from the group including prepreg method, wet pressing method, resin infusion method, foil lamination method, and vacuum (VARI-)method, and especially preferred a powder prepreg method, a liquid prepreg method or by a wet pressing method. In the semi-finished textile products manufactured in this manner, the fiber material is surprisingly especially homogenously embedded in the matrix, so that the resin shrinkage during the hardening of the matrix can be almost completely prevented.

The semi-finished product according to the invention can be returned directly or in a consolidated form in the manufacturing process. Examples for these applications are the manufacture of a structural component or a outer skin component of a motor vehicle, of a rail vehicle or a transport vehicle using the semi-finished textile product.

The present invention is also desirous to provide an improved carbon fiber reinforced composite material which can be obtained by hardening of the cross linking, matrix of the previously semi-finished textile product.

In this connection, hardening takes place in dependence on the actually utilized matrix material, preferably at a temperature of between 0 and 300° C. Currently preferred is a temperature between 25 and 200° C.

Moreover, the present invention involves also a carbon fiber-reinforced composite material which can be obtained by a thermal deformation and optionally after compacting of a thermoplastic matrix of the previously described semi-finished textile.

In this connection, the thermal deformation and the after compacting takes place in dependence on actually used matrix material, for example, in the case of a matrix material of partially crystalline thermoplastic material, preferably at a temperature of between 0 and 200° C., and especially preferred at a temperature between 25 and 100° C. above the melting temperature of the thermoplastic material, and, for example in the case of a matrix material of amorphous thermoplastic material, preferably at a temperature of between 0 and 400° C., and especially preferred at a temperature, of between 10 and 200° C. above the glass transfer temperature of the thermoplastic material.

According to another advantageous feature of the present invention, the carbon-reinforced composite material according to the invention can have a fiber content of between 20 and 60%, preferably between 30 and 50%, especially preferred between 35 and 45%. Currently preferred is a fiber content of 40%.

According to another advantageous feature of the present invention, the carbon fiber-reinforced composite material can have a tensile strength of 100 to 2000 N/mm² and preferably 200 to 800 N/mm², and an elasticity modulus of 5 to 180 GPa, preferably of 10 to 80 GPa.

Finally the present invention concerns the use of the above-described semi-finished textile product for manufacturing components, such as, for example, a structural component or an outer skin component of a motor vehicle, a rail vehicle, or a transportation vehicle.

### BRIEF DESCRIPTION OF THE DRAWING

NONE

### DETAILED DESCRIPTION

In the following, the present invention will be described with the aid of examples which explain but do not limit the invention.

### EXAMPLES

### Example 1

### Manufacture of a Prepreg on the Basis of a Carbon Fiber Fabric, Manufactured from Processing Wastes and a Matrix of an Epoxide Resin and the Further Processing Thereof

On a laboratory-coating plant, a prepreg was manufactured from a carbon fiber fabric which includes carbon fiber cutting wastes of the company SGL ACF GmbH, Germany, and from a liquid epoxyde resin formula of the SGL group with the name FT-109-1 which was characterized by a hardening at a temperature of between 80 and 150° C. at an achievable glass transfer temperature of up to 120° C.

The carbon fiber fabric was manufactured with a area weight of about 103 g/m² from cutting wastes from the filament bundles with a length of between 20 and 250 mm, namely, by the work steps comminuting the cutting wastes, opening the filament strands; mixing the opened filament strands, combing, apply an adhesive material, namely an adhesive fabric, confectioning and winding. The carbon fibers had as determined according to ASTM D5291-02 a carbon content of more than 90% by weight in relation to the total weight of the fibers. Moreover, the carbon fiber fabric had a proportion of cotton and polyester threads whose content did not exceed 20%. Moreover, the carbon fibers were pre-oriented during the fabric manufacture, so that a certain anisotropic behavior with respect to the fiber alignment and thus the mechanical properties was adjusted.

The coating plant includes a winding unit each for coating paper or carrier paper and the carbon fiber fabric, a coating unit, a first calendar, a furnace unit, a second calendar, a cooling plate as well as a winding unit. After the application of a film of the epoxide resin and the coating paper with a very defined basic weight of 115 g/m² (+/−3 g/m²), the carbon fiber fabric was placed in the resin film and consolidated in the first calendar into a first impregnation. Subsequently, the preimpregnated semi-finished product was introduced into a furnace adjusted to 130° C., in which the actual impregnation took place, on the one hand, by the decreasing viscosity of the resin due to the rising temperature as well as the suction effect of the fabric which started as a result, and on the other hand the resin was staged, i.e. prepolymerized. The achieved polymerization degree was at 40%. The prepreg which was still hot was then guided through the second calendar for the further compacting, was subsequently cooled on a cooling plate until the prepreg temperature was lower than 40° C., and was finally wound in the winding unit under a tensile tension of 450 N.

The prepreg manufactured in this manner was then processed into a carbon fiber-reinforced plastic material (CFK). For this purpose, several layers of the prepreg where cut on a lever cutting machine into square pieces and were placed on each other symmetrically with respect to the center. Subsequently, the carbon fiber fabric prepreg was initially pressed at a temperature of 160° C. for an hour, under pressure of 42 bar. Basically, pressing can be carried out at temperatures of 130 to 180° C. over a period of time of up to 1 hour as well as under a pressure of 0.1 bar, preferably from 1 to 100 bar, especially preferred under a pressure of 5 to 30 bar.

Using the above method, a variation of the temperature used for hardening and the duration of the hardening, various CFK's were obtained, wherein substantially homogenous composite material plates are obtained. The concrete hardening conditions for the individual tests as well as the characterizing values of the composite material plates manufactured in this manner are summarized in the table below.

TABLE 1
Carbon fiber fleece prepreg - characterizing values

| | | | | |
|---|---|---|---|---|
| Total surface weight | 218 g/m² | +/−20 | g/m² | DIN EN 2557 |
| Fiber surface weight | 103 g/m² | +/−15 | g/m² | DIN EN 2329 |
| Resin content | 115 g/m² | +/−3 | g/m² | DIN EN 2559 |

| | | | |
|---|---|---|---|
| Resin: | FT-109-1 | Epoxide resin | |
| | | hardening | |
| Glass transfer | >90° C. | 15 min @ 130° C. | DMA, RT-200° C. |
| temperature | >110° C. | 60 min @ 130° C. | with |
| achieved | >98° C. | 15 min @ 150° C. | 3K&min; Onset E′ |
| independence on | >93° C. | 15 min @ 180° C. | |
| the hardening | | | |
| conditions | | | |

For the aforementioned four samples the 3-point-bending strength, the 3 point modulus, the breaking tension, density and fiber volume content were set. The measuring method used for this purpose as well as the obtained results for the sample hardened of 130° C. for 60 min. are listed in the following table 2.

| Measurement | Measuring | | Testing | Average | Deviation |
|---|---|---|---|---|---|
| parameters | methods | unit | direction | value | +/ − |
| 3-point bending | ISO-14125 | MPa | 0° | 563.6 | 34.1 |
| stability | | | | | |
| 3-point bending | ISO-14125 | MPa | 0° | 32200 | 900 |
| module | | | | | |
| Breaking | ISO-14125 | % | 0° | 1.9 | 0.1 |
| elongation | | | | | |
| Density | DIN/EN/ISO | g/cm³ | — | 1.37 | 0.01 |
| | 1183-1 | | | | |
| Fiber volume | DIN/EN | Vol. % | — | 35.55 | 1.83 |
| content | 2564 | | | | |

With the other three samples comparable values were obtained.

For completeness' sake, it shall be mentioned, that in the method described above it is possible to use alternatively to the epoxide resin also a thermoplastic or thermoset resin system or another thermoset resin system, This can be done in an organic or inorganic solvent. For this purpose, used as solvents are preferably ketones, such as acetone and methylethylketone, alcohols, ether, ester and the like. The manner of operation is analogously to the described method and differs only by the fact that, in contrast to the aforementioned variation, at least the solvent is removed in the furnace by evaporation.

### Example 2

### Manufactured of a Carbon Fiber Reinforced Synthetic Material on the Basis of a Carbon Fiber Fabric from Recycled Carbon Fiber by Means of Wet Press Method

### Variation 1

A carbon fiber fabric manufactured as described in example 1, from carbon fibers of waste material which were processed to carbon fiber reinforced plastic material (CFK) by means of the wet press method. For this purpose, several layers of the fleece where cut on a lever cutting machine into square pieces and were placed on each other symmetrically with respect to the center. Subsequently, epoxy resin was added to the casting in an amount, which was calculated as to yield a fiber volume content of 35% in the finished construction part. Subsequently the casting press was closed and pressed for 2.5 hours at a temperature of 150° C. and a pressure of 42 bar. Basically, pressing with this system can be carried out at a temperature of 100 to 150° C., for up to 3 hours, preferably for up to one hour and especially preferred for up to 15 minutes, and at a pressure of 0.1 to 1000 bar, preferably from 1 to 100 bar, especially preferred from 5 to 30 bar.

This resulted in very homogenous composite material plates.

### Variation 2

A carbon fiber fabric manufactured as in example 1 is processed from carbon fibers originating from production waste by means of a wet pressing method into carbon-reinforced plastics material (CFK).

For this purpose, several layers of the fabric were cut on a lever cutting machine to square pieces and were alternately placed in a press form with a restrictive resin layer between two carbon fiber fabric layers, so as to be symmetrical with respect to the center. The resin layers were sprayed on, but can also be cast in the form of a resin film into the mold. Subsequently the pressing mold was closed and pressing was carried out at a temperature of 150° C. for one hour as well as under a pressure of 42 bar.

As a result, very homogenous composite material plates were obtained.

### Example 3

### Manufacture of a Prepreg on the Basis of Carbon Fiber Fabrics Manufactured from Processing Waste and the Further Processing into a Thermoplastic Material

On a laboratory-coating plant, a prepreg was manufactured from a carbon fiber fleece, including cutting waste from carbon fiber of the firm SGL ACF GmbH, Germany, and of a solid thermoplastic polymermatrix of poyamid 6.

The carbon fiber fabric had an area weight of about 103 g/m² and included filament bundles having a length of between 20 and 250 mm; this was effected by the work steps comminuting the cutting wastes, opening the filament strands, mixing of the opened filament strands, combing, application of an adhesive material, namely an adhesive fabric, confectioning and winding. The carbon fibers had according to ASTM D5291-02 a carbon content of more than 90% by weight in relation to the total weight of the fibers. Moreover, the carbon fiber fabric had a small proportion of cotton and polyester threads whose contents did not exceed 20%.

The coating plant included a winding unit for coating paper or carrier paper and the carbon fiber fabric, a coating unit, a first calendar, a furnace unit, a second calendar, a cooling plate as well as a winding unit.

Carbon fiber fabric and matrix materials manufactured as described above are combined with each other through each of the three subsequently described method.

### Variation 1—Powder Prepreg

The coating unit included in this case of an up- and down winding unit, a powder caster and a heating field. After the application of the pulverous matrix material on the carbon fiber fabric, this configuration was included in the heating field. The temperature of the heating field was adjusted to 130° C. and the conveying speed of the configuration through the heating field was adjusted in such a way that the powder granulates were sintered, i.e., the kernels were at least at the surface beginning to melt or even completely melted. As a result, a adherence of the powder to the carbon fiber fabric was achieved. During this process, however, there was still no significant impregnation of the fabric.

Following the first coating and fixing analogous to the above described procedure, a second coating was carried out on the previously non-coated side. By the coating on both sides a particularly uniformity and planeness of the powder prepreg was achieved. However, this method step is optional.

The powder prepreg manufactured in this manner had a area weight of 218 g/m².

Some of the powder prepregs manufactured in this manner were subsequently consolidated or compacted or impregnated by heated calendars, while the temperature was 100° C. above the glass transfer temperature of the used polymer.

Thus the polymer was introduced into the carbon fiber fabric and compacted into an organic sheet. Subsequently, the consolidated organic sheet was cooled and wound or cut to plates.

### Variation 2—Foilcoating

In this variation, the thermoplastic polymer which later formed the matrix, was presented in the form of foils and was continuously guided together in the carbon fiber fabric. The polymer foils were guided from two sides, although feeding from one side is also possible. After bringing the polymer foils and the carbon fiber fabric together, the material was consolidated, or compacted or impregnated together by heated calendars, wherein the temperature in this case was 100° C. above the glass transfer temperature of the polymer used.

Consequently, the polymer was placed in the carbon fiber fabric and compacted into a organic sheet. The consolidated organic sheet was cooled down and wound up or cut into plates.

Variation 3 Slurry Impregnation by a) Immersion b) Nozzle Application c) Film Transfer (Incl. Solvent)

In this variation, the matrix polymer was available in the form of a suspension in a solvent. Used as solvent was water, although an inorganic or organic solvent could be used, such as, for example, a ketone, acetone or methylethylketon, an alcohol, an ether, an ester or the like, or a mixture of various solvents. The solvents or suspensions may optionally contain stabilizers, such as tensides or watersolulabe polymers, such as polyvinyl alcohol, but also further substances which cause a stabilization of the suspension. The coating plant included a winding unit for the carbon fiber fabric, a coating unit, a first calendar, a furnace unit, a second calendar, a cooling plate as well as a winding unit.

The matrix was combined with the carbon fiber fabric over the three types described in the following

### Subvariation 1—Slurry—Immersion:

In the immersion impregnation with the suspension, the carbon fiber fabric was unwound, pulled for impregnating by a foulard, squeezed by means of dosing rollers and guided into a dryer in which the solvent was evaporated and the polymer was heated. The powder coated prepreg, as a result of this impregnation was consolidated or compacted or impregnated by a heated consolidation section, namely consolidated, or compacted or impregnated in a calendar, wherein the temperature was 100° C. above the glass transfer temperature of the polymer used.

Consequently, the polymer was introduced into the carbon fiber fabric and compacted into a semi-finished product, namely in a row of test into an organic sheet, and in another series of tests into a prepreg. The consolidated semi-finished product was finally cooled and wound up or cut into plates.

### Subvariation 2—Slurry Nozzle Application:

In the nozzle application of the suspension, the suspension was directly applied by means of a wide slot nozzle onto carbon fiber fabric, was guided through a calendar for impregnation and subsequently guided into a dryer in which the solvent was evaporated and the polymer was heated. The prepreg obtained by this impregnation was consolidated or compacted or impregnated by a calendar, wherein the temperature was 100° C. above the glass transfer temperature of the polymer used.

As a result, the polymer was introduced into the carbon fiber fabric and compacted into a semi-finished product, namely a in a row of test into a organic sheet and in another row of test into prepreg. The consolidated semi-finished product was finally cooled and wound up or cut into plates.

### Subvariation 3—Slurry—Film Transfer:

In this variation, the coating plant included a winding unit for coating paper and the carbon fiber fabric, a coating unit, a first calendar, a furnace unit, a second calendar, a cooling plate as well as a winding unit.

After applying the suspension on the coating paper with a very defined grammage of 115 g/m² (+/−3 g/m²) the carbon fiber fabric was placed in the resin film and consolidated in the first calendar into a first impregnation. Subsequently, the impregnated material was guided into a dryer, in which the solvent was evaporated and the polymer was heated. The prepreg obtained by this impregnation was consolidated or compacted or impregnated by a heated consolidation section, namely a calendar, wherein the temperature was 100° C. above the glass transfer temperature of the polymer used.

As a result, the polymer was introduced into the carbon fiber fabric and compacted into a semi-finished product, namely in a test row into an organic sheet, in another test row into a prepreg. The consolidated semi-finished product was finally cooled and wound up or cut into plates.

The reuse of materials in the automobile industry as required by law requires new concepts for processing and using waste materials. In particular in view of the increase replacement of composite material of fibers and resin systems, concepts for realizing a utilization of the materials must be found. In this connection, the processing and use of recyclable materials on the basis of carbon fibers is most significant. At the present time, methods are being developed which have as their goal the processing of the mentioned wastes in the form of non-woven fabrics. The focus in this connection is the processing of such fabric materials by means of RTM technology into CFK structural components.

For example, the prior art has the following disadvantages.

Processing by means of RTM: Poor impregnability of the fabrics on the basis of recycled carbon fibers because of the high density and the resulting low permeability.

In outer skin components: At the present time, for outer skin components (visible structural components) structural structures must be converted in the RTM/prepreg method into CFK components. In this connection, it is necessary to carry out difficult processing steps because of the insufficient surface qualities (in fabrics resin shrinkage in points of intersections). In this case, there is a clear demand for semi-finished products having a high surface quality.

In structural components, in most cases anisotropic nest-type fabric structures are used. However, the issue frequently is coming up in connection with quasi isotropic load conditions. In connection with a draping capability, the return of materials into the material cycle, but also a simpler manipulation, are also the reason for a significant requirement for a new material.

In order to overcome the disadvantages of the state of the art, the manufacture of prepregs, of recycled carbon fiber wastes in the form of fabrics is proposed.

In accordance with the invention, semi-finished textile products can be formed of fiber wastes (cuttings, fabrics, nest-type fabric, wastes) and processed prepregs and CFK wastes. Prepreg and CFK wastes can be once again returned to the value creation cycle.

The method developed in accordance with the invention is based, for example, on non-woven fabrics or fleeces of recycled carbon fibers (or, for example, mixtures with other fibers), as well as, for example, combinations with cover fleeces which are impregnated with a matrix during a subsequent processing step.

The prepreg method according to the present invention has distinguished itself as an especially advantageous improved method for the described textile structure because the material is desired to be having low tension and, thus, can be processed without destruction/deformation. Moreover, only short impregnation distances have to be traveled due to the thickness of the textile structure).

Because of the relatively low strength of the fabric structures, the following must be taken into consideration during processing of the material into a prepreg:

Preferred tension relief of the fabric structure for avoiding destruction or deformation/distortion.

Preferred combination of the fabrics with fabrics, nest-type fabric, UD-strands, belts, support fabrics, fleeces.

Preferably, the mentioned fabrics, nest-type, fabrics, UD-strands, belts, support fabrics, and felts can consist of carbon fibers, glass fibers, polymer fibers (polyamide, polyester, polypropylene, polyacrylnitril, copolymers etc.) as well as mixtures of the mentioned material classes.

The combination can be carried out directly at the prepreg process, however, it may also take place in a prior process, or preferably also in the manufacture of the non-woven fabric.

A particularly preferred use of the material takes place as a coating for foil/paper which essentially receives tensile forces caused by the process during the prepreg process.

These foils may preferably be composed of thermoplastic films/foils, as well as coated films/foils (for example polyester films or coated polyester films), but also of coating papers with a sufficient basic weight.

The prepreg plant is preferably run with low voltage, wherein the discharge voltages, especially of the structure of the non-woven fabric, should preferably be selected low.

The matrix material can preferably be a thermoset resin (for example epoxide resin), on the other hand the material may preferably also be a thermoplastic resin. The resin may preferably be a “hot-melt” resin in the form of powder emulsion/suspension or as solution which is applied by spraying, immersion, casting, painting (direct or indirect) or the like.

The applied resin is in the case of thermoset resins (e.g. epoxide resin formulations) preferably staged (thermally/chemically), wherein an increase of the molecular weight takes place.

As a result, the matrix preferably obtains a higher stability and, thus, improves the manipulation. Especially preferred as a result is a stabilization of the prepreg fabric of recycled carbon fiber wastes.

In the case of thermoplastic matrices, the thermoplastic material is preferably fixed by melting of powder on fabric and is impregnated in a pressing process.

Alternatively, a thermoplastic foil can preferably be applied on one side or more thermoplastic foils on both side of the fabric (for example, by calendaring).

This thermoplastic foil can preferably be a tension release foil.

The obtained prepreg can preferably be returned to the manufacturing process directly or also in a consolidated form to the manufacturing process. For example, are primarily outer skin/structural components of automobiles and further transport agents (for example, rail vehicles) by means of a quasi homogeneous distribution of fiber and resin, the tunneling of the “hardened resin” is preferably minimized. Such an advantage can be found in the material and material recycling products which avoids the particularly complicated surface cuts.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of manufacturing a semi-finished textile product from carbon fibers obtained from a matrix material, the method comprising the steps of:
a) manufacturing a non-woven fabric composed of at least 10% carbon fibers and/or a fleece composed of at least 10% carbon fibers, wherein at least a portion of the fibers used for the manufacturing of the fabric or fleece are waste fibers and/or recycling fibers, and
b) impregnating the non-woven fabric and/or fleece with a matrix material, selected from the group consisting of thermoplastic material, thermoset materials, elastomers and any chosen mixtures of two or more of the aforementioned materials.

2. The method according to claim 1, comprising carrying out the impregnation of the fabric and/or the fleece with the matrix material in step b) by a method selected from the group which includes prepreg methods, wet pressing methods, resin infusion methods, foil calendaring methods and vacuum supported VARI-methods.

3. The method according to claim 2, comprising carrying out the impregnation of the fabric and/or the fleece with the matrix material in step b) by a liquid prepreg method, by a powder-prepreg method and/or a wet pressing method.

4. Method according to claim 2, comprising using in step a) for manufacturing the fabric and/or fleece a fiber mixture which contains at least 20%, preferably at least 50%, particularly preferred at least 80%, especially preferred at least 90% and especially preferred at least 95% and most preferred completely of waste fibers and/or recycling fibers.

5. The method according to claim 4, wherein in step a) waste fibers and/or recycling fibers are used of which at least 10%, preferably at least 30%, especially preferred at least 60%, and very particularly preferred at least 80% and most preferred 100% carbon fibers.

6. The method according to claim 5, wherein in step a) recycling fibers are used which have been manufactured of waste in the form of fabric of nest-type fabric, of knitted material, of fiber material which has been preimpregnated with a matrix material, with composite material containing fibers, especially of carbon fibers containing carbon material, or a freely selected mixture of two or more of the aforementioned materials.

7. The method according to claim 6, comprising using the non-woven fabric or the fleece in combination with at least one other fiber material, wherein the other fiber material is selected from the group consisting of fabrics, nest-type fabric, unidirectional UD-strands, belts, non-woven fabrics, fleeces and any other mixture two or more aforementioned materials.

8. The method according to claim 7, comprising arranging the individual fiber materials in the form of a laminate, wherein the laminate comprises at least one fiber layer and at least one fabric layer and at least one nest-type fabric layer.

9. The method according to claim 7, wherein as the other fiber material is used a fiber material containing waste fibers and/or recycling fibers placed in the carbon material, wherein the individual fiber materials are arranged in the form of a laminate, wherein the laminate consists of at least one fabric layer and at least one woven layer, or of at least one fleece layer and at least one nest-type fabric layer.

10. The method according to claim 7, comprising using as the other fiber material a fiber material composed of waste fibers and/or recycling fibers, and contains recycling fibers composed of carbon fibers, glass fibers, polymer fibers and mixtures of two or more aforementioned materials, wherein the polymer fibers are preferably polyamide fibers, polyester fibers, polypropylene fibers, polynitril fibers, fibers of oxidized polyacryl nitril, fibers of copolymers of two or more of the aforementioned materials and mixtures of two or more of the aforementioned materials.

11. The method according to claim 10, wherein in step b) a matrix material is inserted selected from the group consisting of epoxyde resins, phenol resins, vinyl ester resin, polyester resins, polyurethane resins, benzoxazine resins, novolakes, cyanateester resins, bismaleimide resins, bisoxazolines, polyolefines, such as, for example, polypropylene, technical thermoplastic materials, such as, for example, polyamides and any chosen mixtures of two or more of the aforementioned materials.

12. The method according to claim 11, wherein the fabric or fleece in step b) is provided with a content of matrix material of between 1 and 90% by weight, preferably between 30 and 70% by weight, especially preferred between 40 and 65% by weight.

13. The method according to claim 12, comprising effecting the impregnation of the fabric and/or the fleece by the matrix material in step b) by a powder prepreg method or by a liquid prepreg method, wherein the fabric or fleece is coated on one side or on both sides with a carrier material, preferably with a carrier foil or a carrier paper.

14. A semi-finished textile product, particularly prepreg, comprising carbon fibers preimpregnated with a matrix material and obtained by a method according to claim 1.

15. Carbon fiber reinforced composite material, obtained by hardening or thermally deforming and optionally after compacting a semi-finished textile product according to claim 14.

16. Carbon fiber reinforced composite material, according to claim 15,
wherein the material contains a fiber content of
between 20 and 60%,
preferably between 30 and 50%,
preferred between 35 and 45% and
especially preferred of 40%.

17. Carbon reinforced fiber composite material according to claim 16, wherein the material has a tensile strength of 100 to 2,000 N/mm² and preferably of 200 to 800 N/mm², and/or an elasticity modulus 5 to 180 GPa and preferably of 10 to 80 GPa.

18. Use of a semi-finished textile product according to claim 14 for manufacturing components, such as for example structural component of a motor vehicle, a rail vehicle or a transportation vehicle.
